(19) United States
(12) Patent Application Publication
(10) Pub. No.: US 2011/0066731 A1
(43) Pub. Date: Mar. 17, 2011

(54) Dynamic Application Server Allocation in an IMS Network

(75) Inventors: Jonas Falkenã, Huddinge (SE); Håkan Österlund, Ekero (SE); Per Roos, Jama (SE)

(73) Assignee: TELEFONAKTIEBOLAGET L M ERICSSON (PUBL), Stockholm (SE)

(21) Appl. No.: 12/992,033

(22) PCT Filed: Jun. 25, 2008
(86) PCT No.: PCT/EP08/58113

§ 371 Date: Nov. 10, 2010

(51) Int. Cl. G06F 15/173

(52) U.S. Cl. 709/226

(57) ABSTRACT

A method of dynamically allocating a user to one of a pool of Application Servers within an IP Multimedia Subsystem network. The pool of Application Servers is configured to provision an IP Multimedia Subsystem service. The method comprises determining a level of historical use of said service by said user. The user is then allocated to an Application Server based upon said use and the current load distribution across the Application Servers.

### FIELD OF THE INVENTION

The present invention relates to a method and apparatus for dynamically allocating Application Servers to users in an IP Multimedia Subsystem network in order to achieve improved load balancing across the Application Servers.

### BACKGROUND TO THE INVENTION

IP Multimedia services provide a dynamic combination of voice, video, messaging, data, etc. within the same session. By growing the number of basic applications and the media which it is possible to combine, the number of services offered to the end users (e.g. subscribers) will grow, and the inter-personal communication experience will be enriched. This will lead to a new generation of personalised, rich multimedia communication services, including so-called “combinational IP Multimedia” services.

IP Multimedia Subsystem (IMS) is the technology defined by the Third Generation Partnership Project (3GPP) to provide IP Multimedia services over mobile communication networks (3GPP TS 22.228, TS 23.228, TS 24.229, TS 29.228, TS 29.229, TS 29.328 and TS 29.329 Releases 5 to 7). IMS provides key features to enrich the end-subscriber person-to-person communication experience through the use of standardised IMS Service Enablers, which facilitate new rich person-to-person (client-to-client) communication services as well as person-to-content (client-to-server) services over IP-based networks. The IMS makes use of the Session Initiation Protocol (SIP) to set up and control calls or sessions between subscriber terminals (or subscriber terminals and application servers). The Session Description Protocol (SDP), carried by SIP signalling, is used to describe and negotiate the media components of the session. Whilst SIP was created as a subscriber-to-subscriber protocol, IMS allows operators and service providers to control subscriber access to services and to charge subscribers accordingly.

By way of example, FIG. 1 illustrates schematically how the IMS fits into the mobile network architecture in the case of a GPRS/PS access network (IMS can of course operate over other access networks). Call/Session Control Functions (CSCFs) operate as SIP proxies within the IMS. The 3GPP architecture defines three types of CSCFs: the Proxy CSCF (P-CSCF) which is the first point of contact within the IMS for a SIP terminal; the Serving CSCF (S-CSCF) which provides services to the subscriber that the subscriber is subscribed to; and the Interrogating CSCF (I-CSCF) whose role is to identify the correct S-CSCF and to forward to that S-CSCF a request received from a SIP terminal via a P-CSCF.

A subscriber registers with the IMS using the specified SIP REGISTER method. This is a mechanism for attaching to the IMS and announcing to the IMS the address (“contact”) at which a SIP subscriber identity can be reached. In 3GPP, when a SIP terminal performs a registration, the IMS authenticates the subscriber, and allocates an S-CSCF to that subscriber from the set of available S-CSCFs. Whilst the criteria for allocating S-CSCFs is not specified by 3GPP, these may include load sharing and service requirements. It is noted that the allocation of an S-CSCF is key to controlling (and charging for) subscriber access to IMS-based services. Operators may provide a mechanism for preventing direct subscriber-to-subscriber SIP sessions which would otherwise bypass the S-CSCF.

During the registration process, it is the responsibility of the I-CSCF to select an S-CSCF if an S-CSCF is not already selected. The I-CSCF receives the required S-CSCF capabilities from the home network's Home Subscriber Server (HSS), and selects an appropriate S-CSCF based on the received capabilities. [It is noted that S-CSCF allocation is also carried out for a subscriber by the I-CSCF in the case where the subscriber is called by another party, and the subscriber is not currently allocated an S-CSCF.] In the case where multiple HSSs are deployed in a network, a Subscription Locator Function (SLF) is used by the I-CSCF to identify the correct HSS for a subscriber. When a registered subscriber subsequently sends a session request to the IMS, the P-CSCF is able to forward the request to the selected S-CSCF based on information received from the S-CSCF during the registration process.

Within the IMS service network, Application Servers (ASs) are provided for implementing IMS service functionality. Application Servers provide services to end-subscribers in an IMS system, and may be connected either as end-points over the 3GPP defined Mr interface, or “linked in” by an S-CSCF over the 3GPP defined ISC interface. In the latter case, Initial Filter Criteria (IFC) are used by an S-CSCF to determine which Applications Servers should be “linked in” during a SIP Session establishment (or indeed for the purpose of any SIP method, session or non-session related). The IFCs are received by the S-CSCF from an HSS over the Cx interface during the IMS registration procedure as part of a subscriber's Subscriber Profile. The interface between the S-CSCF and the AS is defined as the ISC interface.

In order to ensure sufficient capacity and robustness within an IMS network, for any given service a pool of ASs may be provisioned. Thus, a given S-CSCF has multiple ISC interfaces to respective ASs, whilst a given AS may have multiple ISC interfaces to respective S-CSCFs. IMS TS23.228 (Annex J) specifies a mechanism for the dynamic allocation of users to ASs at IMS registration. Allocation is performed by the S-CSCF, typically on a round-robin basis, to ensure that users are evenly spread across the ASs available to the S-CSCF. As the HSS is already responsible for the load sharing of users across S-CSCFs in the network it can be expected that this approach will result in an even spread of users across all ASs within the network.

This round-robin based mechanism assumes however that users use the service (provisioned by the AS pool) equally. If, as will normally be the case, this assumption is not valid, an uneven load will likely arise across the ASs as one AS could be allocated a large number of highly active users and another AS could be allocated users that rarely use the service. An overload situation can occur in one AS despite the fact that spare capacity is available in another

AS.

### SUMMARY OF THE INVENTION

It is an object of the present invention to employ a knowledge of the service use history of users when allocating users to Application Servers within the IMS.

According to a first aspect of the present invention there is provided a method of dynamically allocating a user to one of a pool of Application Servers within an IP Multimedia Subsystem network. The pool of Application Servers is configured to provision an IP Multimedia Subsystem service. The method comprises determining a level of historical use of said service by said user. The user is then allocated to an Application Server based upon said use and the current load distribution across the Application Servers.

For each user of the IP Multimedia Subsystem network, a user counter may be maintained to record a use frequency of said service, said step of determining a level of historical use making use of the counter associated with the user being allocated to an Application Server. The user counters may be maintained at a Home Subscriber Server or at another central database.

Said step of determining a level of historical use may comprise deriving from the associated counter value a relevance value. The step of allocating the user to an Application Server then comprises inspecting the current relevance values of Application Servers already allocated to the Application Servers, and selecting an Application Server which tends to achieve a balanced load.

Alternatively, for each Application Server an Application Server counter may be maintained and, following allocation of a user to an Application Server, the user counter value for the allocated user added to the Application Server counter. In this case, the step of allocating the user to an Application Server may comprise identifying the Application Server having the lowest counter value, and allocating the user to that Application Server.

In one embodiment of the invention, said step of determining a level of historical use is carried out at a Call Session Control Function of the IP Multimedia Subsystem. The step of allocating the user to an Application Server may also be carried out at the Call Session Control Function.

In an alternative approach, the step of allocating the user to an Application Server is carried out at a Front End distributor of the IP Multimedia Subsystem, the Front End distributor being located logically between a plurality of Call Session Control Functions and said Application Servers.

According to a second aspect of the invention there is provided apparatus configured for use within an IP Multimedia Subsystem and comprising a first processing unit for monitoring a user load distribution across a pool of Application Servers used to provision an IP Multimedia Subsystem service. A second processing unit identifies a level of historical use for a user being registered for said service, and a third processing unit allocates said user to an Application Server in dependence upon both said user load distribution and said level of historical use.

The level of historical use may be one of a set of predefined levels having respective use thresholds. Alternatively, this level may be a count accumulated over a fixed period.

In a particular embodiment, the apparatus is further configured to operate as a Call Session Control Function. In an alternative embodiment, the apparatus is further configured to operate as a Front End distributor for a plurality of Call Session Control Functions.

### BRIEF DESCRIPTION OF THE DRAWINGS

FIG. 1 illustrates schematically the integration of an IP Multimedia Subsystem into a 3G mobile communications system;

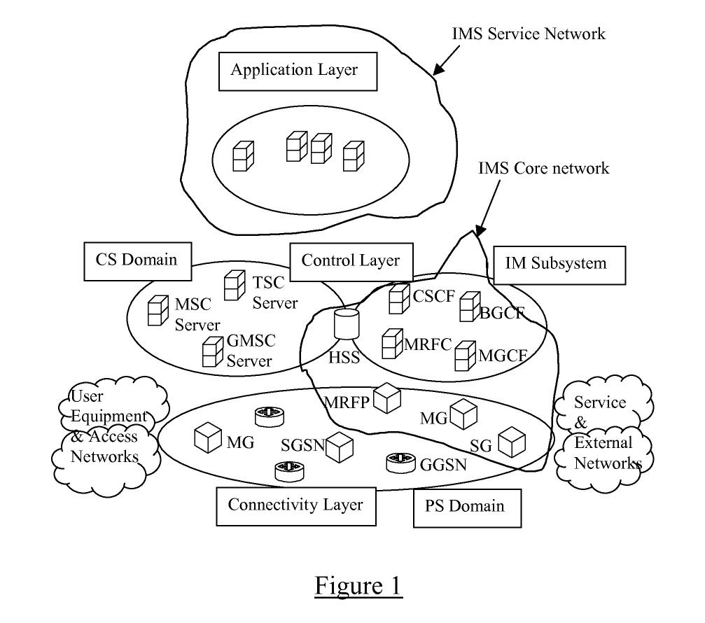

FIG. 2 illustrates schematically components of an IMS network involved in user allocation to ASs;

FIG. 3 illustrates signalling within the IMS associated with a process for dynamically allocating users to ASs;

FIG. 4 is a flow diagram illustrating a process for dynamically allocating users to ASs within an AS service pool;

FIGS. 5 to 7 illustrate various counter states during a user allocation procedure;

FIG. 8 illustrates schematically a CSCF configured to implement the process of FIG. 4;

FIG. 9 is a flow diagram illustrating an alternative process for dynamically allocating users to ASs within an AS service pool;

FIG. 10 illustrates schematically components of an IMS network involved in user allocation to ASs including a FE distributor; and

FIG. 11 is a flow diagram illustrating a user allocation process implemented in the architecture of FIG. 10.

### DETAILED DESCRIPTION OF CERTAIN EMBODIMENTS

WO2008016320 describes a mechanism for collecting user activity information in a telecommunications system and more particularly with an IP Multimedia Subsystem. According to one example, an S-CSCF is provided with an activity template comprising data useable for identifying a signalling message related to a service. In the event that a message relating to a service is identified by the S-CSCF, the S-CSCF reports this fact to the Home Subscriber Server (HSS). This approach provides a means for collecting statistical data regarding the use of a given service by individual users. The information that can be collected using the approach described in WO2008016320 is applied here to dynamically allocate users to Application Servers (AS) based upon the use history of users, thereby potentially improving the load sharing across a pool of ASs.

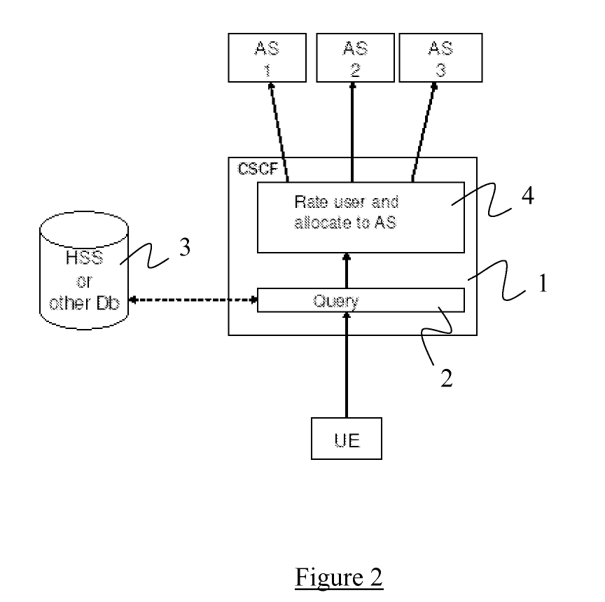

A first approach to applying use history to aid user allocation is illustrated schematically in FIG. 2. Upon receipt of a SIP Register message at a Call Session Control Function (CSCF) 1, typically a S-CSCF, a query unit 2 of the CSCF will query the HSS 3 for an activity counter value associated with the user performing IMS registration, e.g. bob@domain1.com, whilst identifying the service to which the query relates. [Alternatively, the query may be made to some other central database either on a per service basis (e.g. following downloading of the IFCs into the S-CSCF) or in respect of all available services.] The HSS 3 (or other database) maintains an activity counter for each subscriber and for each service applicable to a subscriber. Thus for example, for a given subscriber, the HSS 3 will maintain a counter for services such as voice calls, presence, etc, and will increment a counter each time the subscriber makes use of the associated service. Typically, the counter is reset periodically, e.g. once per month, so that the counter value is in fact indicative of the frequency with which a particular service is used. Employing the approach of WO2008016320, it is of course the CSCF which is primed to collect the statistics and to report these to the HSS over the Diameter interfaces (Cx, Sh).

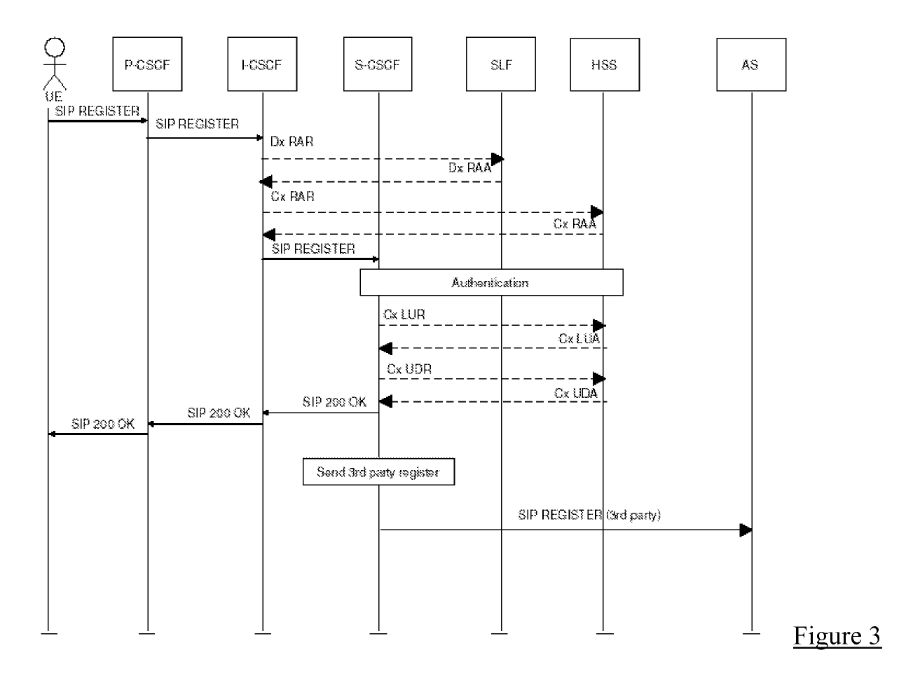

FIG. 3 illustrates a more complete signalling flow for the user registration process, initiated by a UE sending a SIP REGISTER to the IMS, and completed by the S-CSCF sending a third party SIP REGISTER to the selected AS on behalf of the UE.

The HSS 3 returns the requested counter value for the specified user and service to the query unit 2 of the CSCF 1. The result is passed to a user rating and allocation unit 4, which firstly allocates a rating to the user by comparing the counter value against a number of thresholds. Typically ratings may be low, medium, and high. The thresholds defining these ratings can be set by the network operator by analysing use patterns across a sample of users, and can be adapted further by analysing the loads placed on the ASs.

The CSCF maintains a record of the number of users in each category allocated to each AS, i.e. a count of low, medium, and high rated users allocated to each AS. Assuming that all ASs have the same capacity, the user rating and allocation unit 4 of the CSCF will try to ensure that each AS is allocated the same number of users within each category. Users are allocated accordingly.

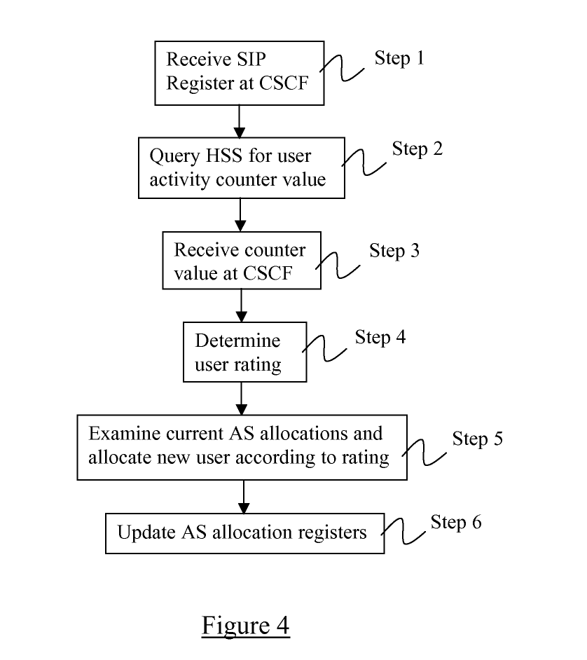

FIG. 4 is a flow diagram showing the user to AS allocation procedure employing use ratings, and carried out on a per service basis. The procedure begins at step 1 with receipt of a SIP Register message at the CSCF. This causes the CSCF to query the HSS for a user counter value associated with the service in question, step 2. At step 3, the CSCF receives the counter value from the HSS and, at step 4, applies the pre-set thresholds to determine a use rating, i.e. low, medium, or high. At step 5 the CSCF examines current AS allocation levels, and allocates the new user based on his/her rating. At step 6 the CSCF updates the current allocation level for the AS to which the new use was assigned.

The approach described above is relatively coarse in that employs only three relevance values, namely low, medium, and high. A finer level of allocation can of course be achieved by defining more relevance values. However, a potentially better approach is to maintain for each AS within a service pool an AS counter, and to add the user activity counter value to the AS counter each time a user is allocated to an AS. Each time a new user is to be allocated, the user is allocated to that AS which currently has the lowest AS counter value.

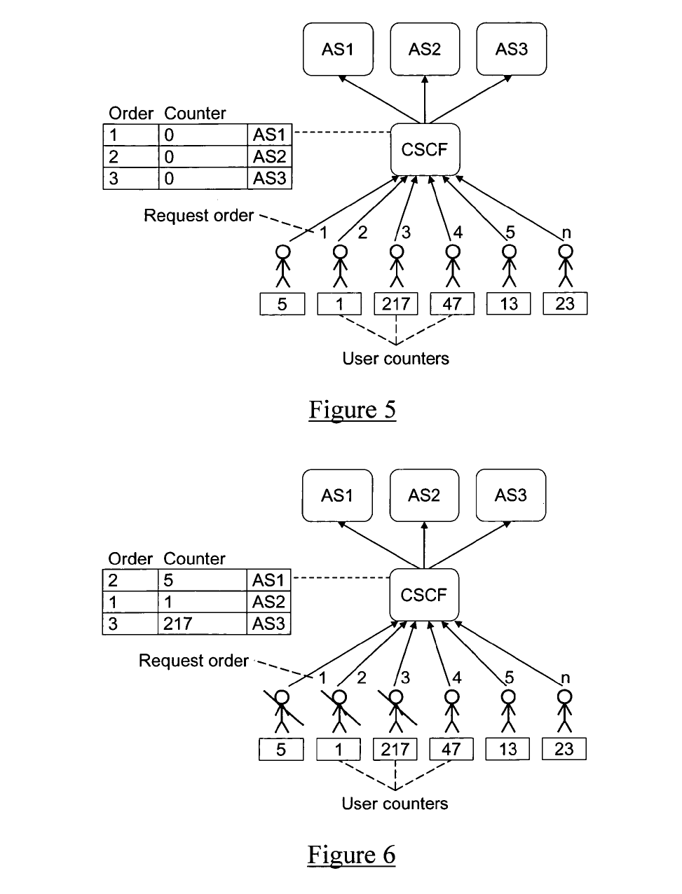

FIG. 5 shows a ‘starting point’ for a CSCF maintaining AS counters for three ASs within a service pool. The AS counters in CSCF are all set to zero, indicating either an initialisation state or that the counters have been cleared on purpose (or by restart). Users are allocated to the ASs in order until at least one user is allocated to each AS. At each allocation and following retrieval of the required user activity counter value from the HSS, the user activity counter value is added to the corresponding AS counter and the AS order is reconfigured such that the AS at the top of the order has the lowest counter value. FIG. 6 shows the counter order after the first three users have been allocated, showing that AS2 is now at the top of the order.

Upon receipt of a fourth registration request, AS2 is at the top of the order, so the new user is allocated to that AS. The counter for AS2 is incremented by the user activity counter value for the new user, 47 in the illustrated example. AS1 now moves to the top of the order. FIG. 7 illustrates the AS order after receipt and handling of request 5. This process continues, with the AS having the lowest counter value always being selected.

When a user-to-server allocation ceases, e.g. when a user de-registers from the IMS system, the appropriate AS counter value in the CSCF is decreased with the user value. The AS order is adjusted as required. So, for example, considering the scenario of FIG. 6, if the most active user (with ‘user counter’=217) is un-allocated from it's AS (AS3), AS3 will move to the top of the order.

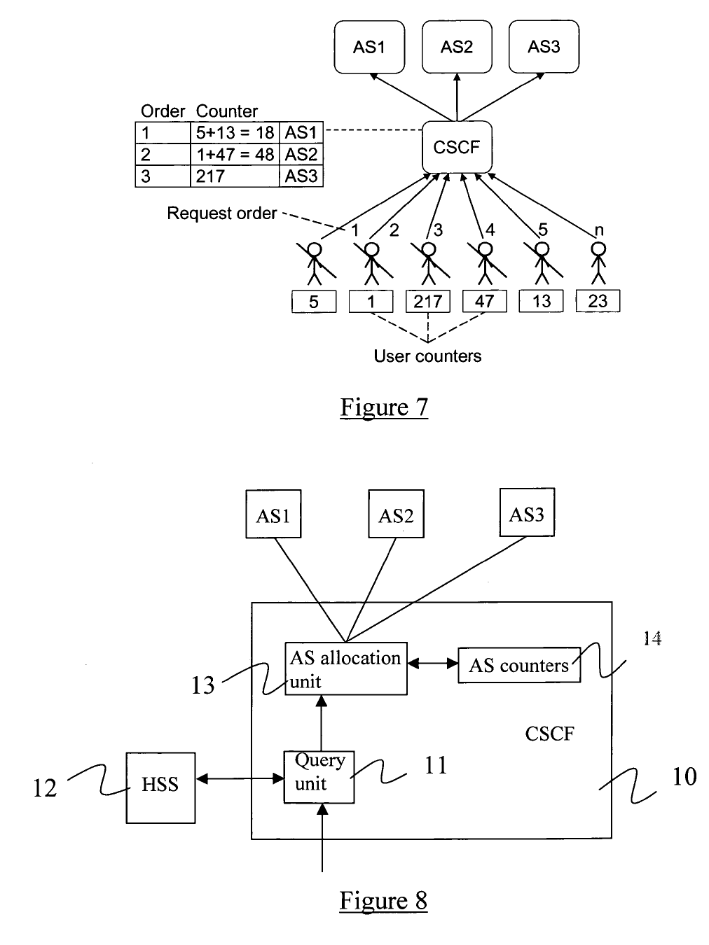

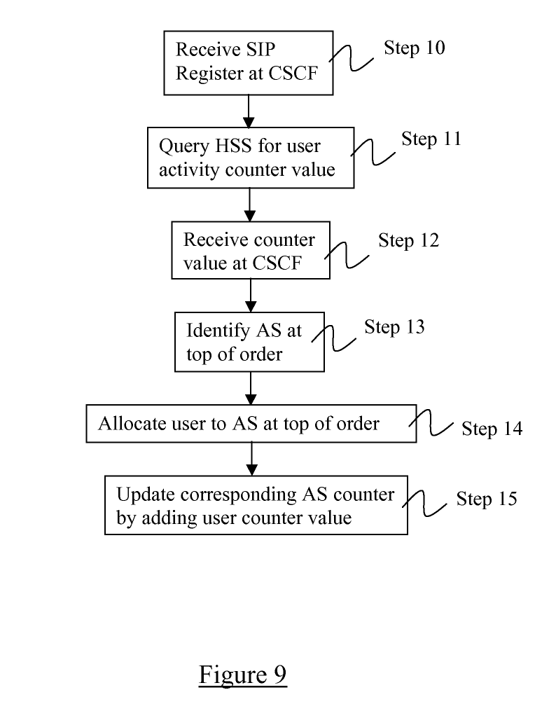

FIG. 8 illustrates schematically a CSCF configured to implement this optimised user allocation scheme. The CSCF 10 comprises a query unit 11 for querying (upon receipt of a Register request) an HSS 12 to obtain user counter values. The counter value is passed to an AS allocation unit 13 which inspects a database 14 containing the current AS counters. The allocation unit identifies the AS at the top of the order, and allocates the user to this. The AS counter is incremented by the user counter value. FIG. 9 is a flow diagram further illustrating this procedure. Upon receipt of a register request at the CSCF, step 10, the CSCF queries the HSS to obtain the counter value for the user in question, step 11. At step 12 the CSCF receives the user counter value and at step 13 identifies the AS currently at the top of the order. At step 14 the CSCF allocates the new user to this AS, and at step 15 adds the user counter value to the corresponding AS counter.

It will be appreciated that the approaches described above may be implemented using computer servers and/or processors configured to perform the described functionality. A CSCF for use with these approaches may in particular be implemented using a set of processor cards with associated RAM and optionally, DSPs. Other embodiments may make use of so-called “blade” servers.

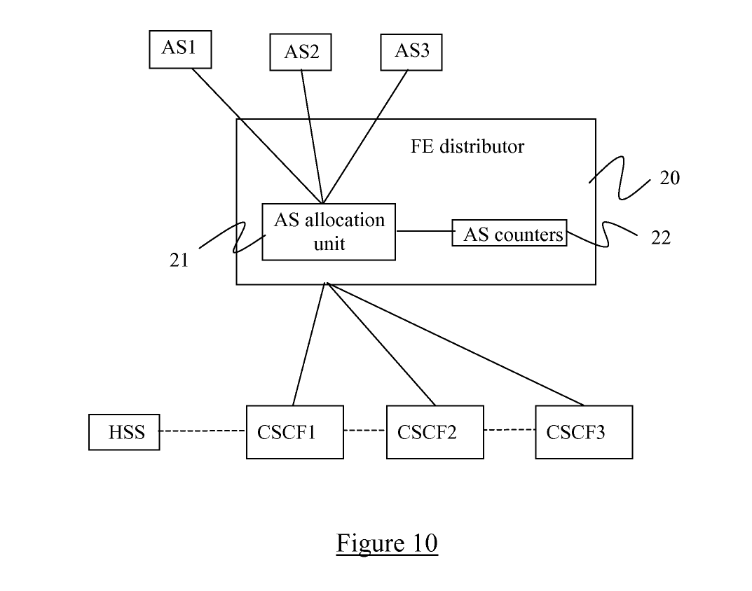

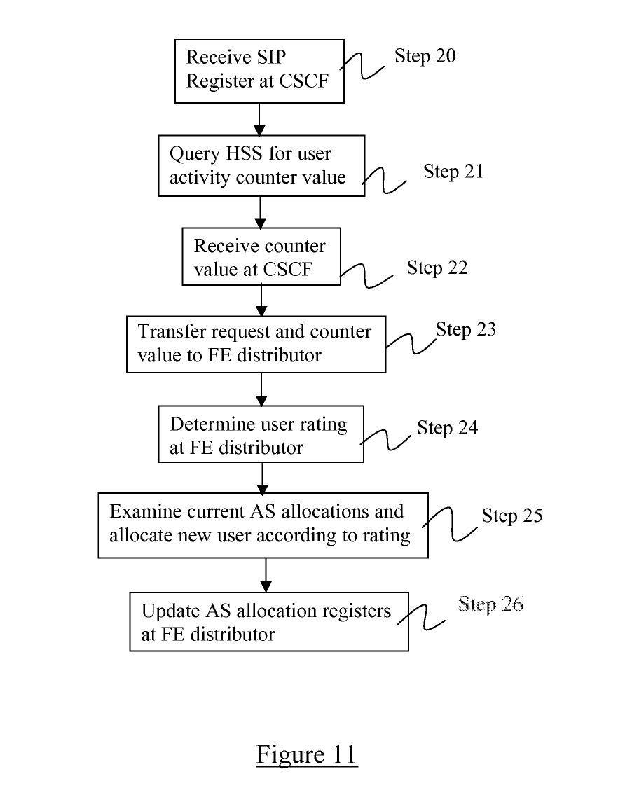

A still further approach to user allocation is illustrated schematically in FIG. 10. It is recognised that the approaches described above are very much CSCF centric in that each CSCF in the IMS network, and which makes use of the services provided by a pool of ASs, is unaware of the allocations made to these ASs by other ASs. According to the architecture of FIG. 10, user allocation is delegated to a Front End (FE) 20 distributor located logically between the CSCFs and the ASs. The FE distributor receives allocation requests from CSCFs, and maintains counters 22 for each AS. Incoming requests are allocated as described above by an allocation unit 21, i.e. to the AS currently at the top of the list. Following allocation of an AS, the FE distributor may or may not notify the requesting CSCF of the identity of the allocated AS, depening upon the details of the implementation. FIG. 11 is a flow diagram further illustrating this process where the steps shown are similar to those described above with reference to FIG. 9, except that at step 23 the request and user counter value are sent from the CSCF to the FE distributor. Of course, rather than using the AS counter approach, the FE distributor may alternatively employ the user rating approach of FIG. 4, applying ratings to users based upon received user counter values. The approach may be modified further by performing the actual rating allocation at the CSCFs themselves, with the CSCFs passing the rating values to the FE distributors. The result is essentially the same.

It will be further appreciated by the person of skill in the art that various modifications may be made to the above described embodiments without departing from the scope of the present invention. For example, whilst the embodiment above concerns a single service scenario, the invention is also applicable to the multi-service scenario, where a user may be allocated a number of different ASs, one per service.

1. A method of dynamically allocating a user to one of a pool of Application Servers within an IP Multimedia Subsystem network, the pool of Application Servers being configured to provision an IP Multimedia Subsystem service, the method comprising:
determining a level of historical use of said service by said user; and
allocating the user to an Application Server based upon said use and the current load distribution across the Application Servers.

2. A method according to claim 1 and comprising maintaining for each user of the IP Multimedia Subsystem network, a user counter recording a use frequency of said service, said step of determining a level of historical use making use of the counter associated with the user being allocated to an Application Server.

3. A method according to claim 2 and comprising maintaining said user counters at a Home Subscriber Server or at another central database.

4. A method according to claim 2, said step of determining a level of historical use comprising deriving from the associated counter value a relevance value, said step of allocating the user to an Application Server comprising inspecting the current relevance values of Application Servers already allocated to the Application Servers, and selecting an Application Server which tends to achieve a balanced load.

5. A method according to claim 2 and comprising maintaining for each Application Server an Application Server counter and, following allocation of a user to an Application Server, adding the user counter value for the allocated user to the Application Server counter.

6. A method according to claim 5, said step of allocating the user to an Application Server comprising identifying the Application Server having the lowest counter value, and allocating the user to that Application Server.

7. A method according to claim 1, said step of determining a level of historical use being carried out at a Call Session Control Function of the IP Multimedia Subsystem.

8. A method according to claim 1, said step of allocating the user to an Application Server being carried out at a Call Session Control Function of the IP Multimedia Subsystem.

9. A method according to claim 1, said step of allocating the user to an Application Server being carried out at a Front End distributor of the IP Multimedia Subsystem, the Front End distributor being located logically between a plurality of Call Session Control Functions and said Application Servers.

10. An apparatus configured for use within an IP Multimedia Subsystem and comprising:
a first processing unit for monitoring a user load distribution across a pool of Application Servers used to provision an IP Multimedia Subsystem service;
a second processing unit for identifying a level of historical use for a user being registered for said service; and
a third processing unit for allocating said user to an Application Server in dependence upon both said user load distribution and said level of historical use.

11. The apparatus according to claim 10, said level of historical use being one of a set of predefined levels having respective use thresholds.

12. The apparatus according to claim 10, said level of historical use being a count accumulated over a fixed period.

13. The apparatus according to claim 10, the apparatus being further configured to operate as a Call Session Control Function.

14. The apparatus according to claim 10, the apparatus being further configured to operate as a Front End distributor for a plurality of Call Session Control Functions.
